(19) United States
(12) Patent Application Publication
(10) Pub. No.: US 2026/0192412 A1
(43) Pub. Date: Jul. 9, 2026

(54) MACHINE TOOL

(71) Applicant: FANUC CORPORATION, Minamitsuru-gun, Yamanashi (JP)

(72) Inventor: Shinichi TANAKA, Minamitsuru-gun, Yamanashi (JP)

(21) Appl. No.: 19/132,980

(22) PCT Filed: Jan. 17, 2023
(86) PCT No.: PCT/JP2023/001172

§ 371 Date: May 27, 2025

(51) Int. Cl. B23Q 17/00; B23B 31/10

(52) U.S. Cl. CPC B23Q 17/003; B23B 31/10; B23B 2260/034

(57) ABSTRACT

A machine tool has an interchangeable tool clamped to a main spindle. The machine tool includes a drawbar which is biased backward by a biasing member and which clamps the tool to the main spindle by moving backward and unclamps the tool from the main spindle by moving forward, an interlocked part which is connected to the drawbar and interlocked with the forward and backward movement of the drawbar, an arm that pushes the interlocked part forward to move the drawbar forward against the biasing member, a proximity sensor which is fixed to either the arm or the part, and the output of which switches on/off depending on the distance between the arm and the part, and a determination unit that determines the clamp state of the tool on the basis of the on/off state of the proximity sensor.

### TECHNICAL FIELD

The present disclosure relates to a machine tool.

### BACKGROUND ART

A machine tool has been conventionally known that clamps a tool disposed at a prescribed position and releases the clamped tool according to need such that the tool is changed with another tool. The machine tool includes a drawbar that is provided in a spindle in such a manner as to be capable of moving forward/rearward, and an arm that presses the drawbar forward during tool change. The drawbar is biased rearward by a spring in the spindle. The drawbar is configured to unclamp a tool by pressed forward by the arm, and clamp the tool by moving rearward by means of the biasing force of the spring when the forward pressing by the arm is released.

### CITATION LIST

### Patent Document

Patent Document 1: Japanese Unexamined Patent Application, Publication No. 2009-178795
Patent Document 2: Japanese Unexamined Patent Application, Publication No. 2018-167377

### DISCLOSURE OF THE INVENTION

### Problems to be Solved by the Invention

When automatically changing a tool, the extension/contraction state of a drawbar is monitored to detect the tool being clamped to a spindle, in order to prevent a machine tool from performing a machining operation in the absence of the tool due to, for example, a failure in the tool change. The extension/contraction state of the drawbar is indirectly detected by one sensor positionally fixed with respect to the spindle.

However, when monitoring the extension/contraction state of the drawbar by using one sensor, although the presence/absence of the tool can be detected, a mis-clamped state cannot be detected in which, for example, the tool is clamped with foreign matter caught between the spindle and the tool. In this situation, a sensor for detecting the mis-clamped state is additionally required, so two or more sensors need to be attached to the machine tool in order to monitor the extension/contraction state of the drawbar.

Accordingly, it is desired to allow for not only the detection of the presence/absence of a tool at the spindle but also the detection of the mis-clamped state of the tool, without increasing the number of sensors to be attached to the machine tool.

### Means for Solving the Problems

A machine tool according to the present disclosure, for which a tool to be clamped to a spindle is capable of being changed, includes: a drawbar that is biased rearward by a biasing member, clamps the tool to the spindle by being moved rearward, and unclamps the tool from the spindle by being moved forward; an interlock component that is connected to the drawbar and interlocks with forward/rearward movement of the drawbar; an arm that presses the interlock component in order to move the drawbar forward against the biasing member; a proximity sensor that is fixed to the arm or the interlock component and provides an output switched between ON and OFF in accordance with the distance between the arm and the interlock component; and an assessment unit that assesses the clamped state of the tool on the basis of the ON/OFF state of the proximity sensor.

### BRIEF DESCRIPTION OF THE DRAWINGS

FIG. 1 is a partial side view of a machine tool according to present embodiments;

FIG. 2 is a partial cross-sectional view illustrating the clamped state of a tool for a machine tool according to present embodiments;

FIG. 3 is a partial cross-sectional view illustrating the unclamped state of a tool for a machine tool according to present embodiments;

FIG. 4 is an enlarged perspective view illustrating the interlock component of a machine tool according to present embodiments;

FIG. 5 is a front view of the interlock component of a machine tool according to present embodiments as viewed in a direction A in FIG. 4;

FIG. 6 is an explanatory functional block diagram of the configuration of the control device of a machine tool according to present embodiments;

FIG. 7A is an explanatory diagram of a machine tool according to present embodiments in the absence of a tool;

FIG. 7B is an explanatory diagram of the clamped state of a tool for a machine tool according to present embodiments;

FIG. 7C is an explanatory diagram of the unclamped state of a tool for a machine tool according to present embodiments;

FIG. 8 is an explanatory diagram of the ON/OFF state of a proximity sensor that is achieved when a tool for a machine tool according to present embodiments is changed normally;

FIG. 9 is an explanatory diagram of the ON/OFF state of a proximity sensor that is achieved when a tool for a machine tool according to present embodiments is not changed normally; and

FIG. 10 is flowchart illustrating assessment processing performed by a machine tool according to present embodiments.

### PREFERRED MODE FOR CARRYING OUT THE INVENTION

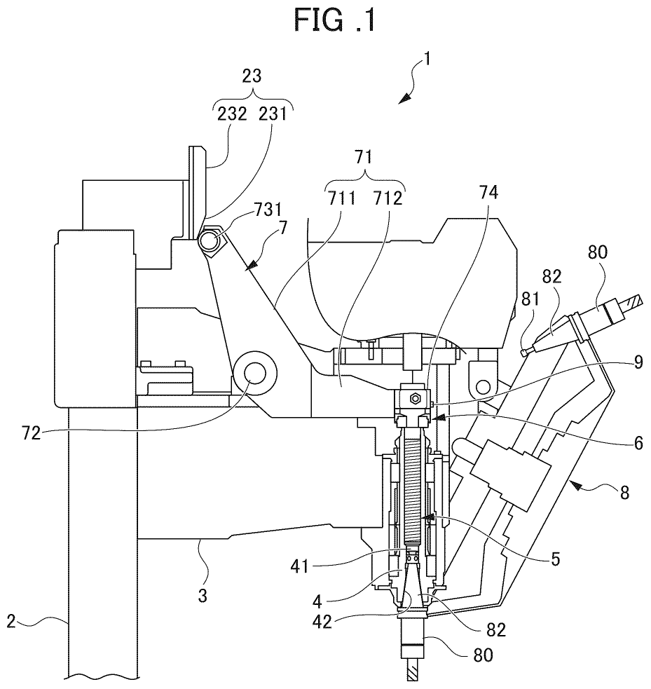

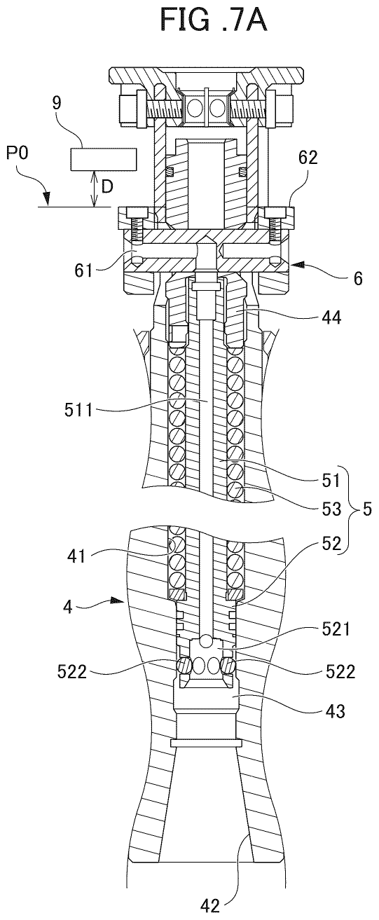

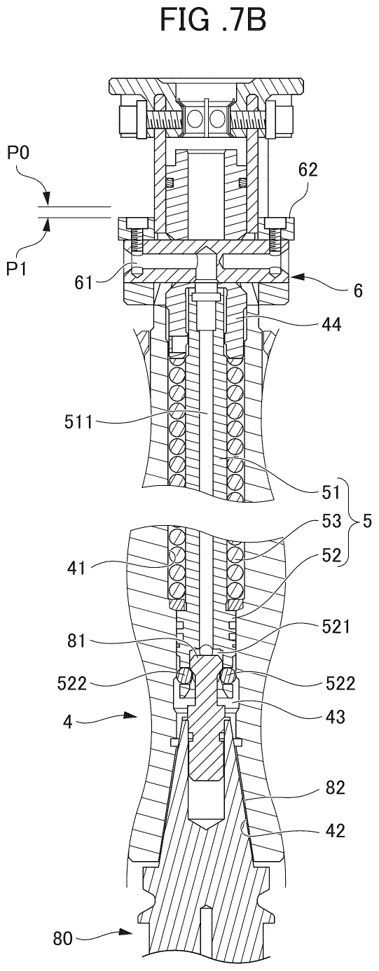

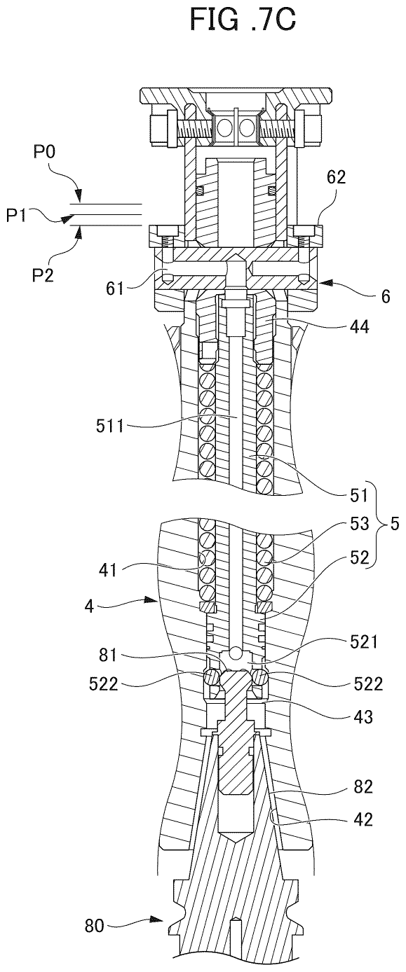

The following describes one embodiment of the present disclosure by referring to the drawings. In FIG. 1, a machine tool 1 includes a column 2, a spindle head 3, a spindle 4, a drawbar 5, an air injector 6, an arm 7, an automatic tool changer 8, a proximity sensor 9, and a controller 10 (see FIG. 7). For example, the machine tool 1 is a machining center.

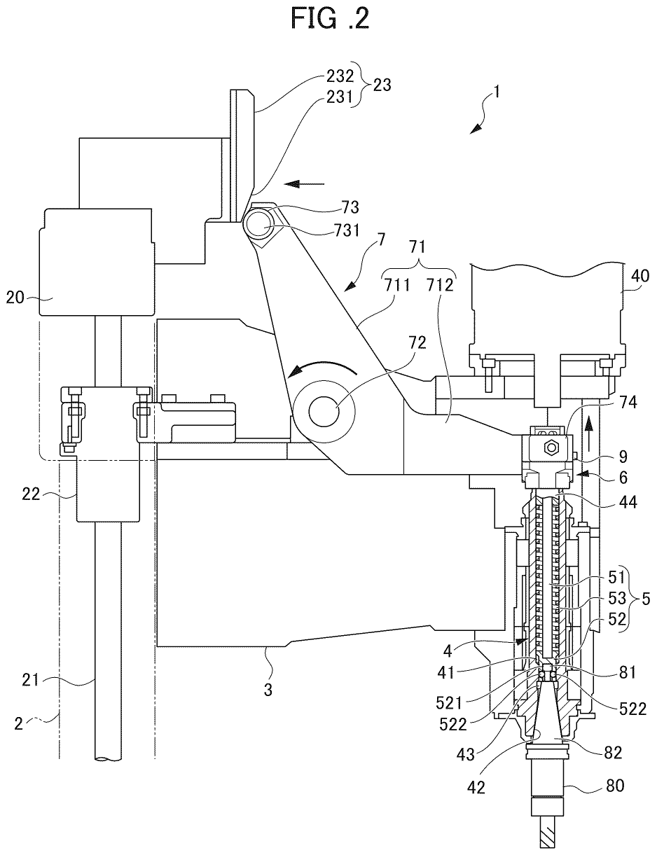

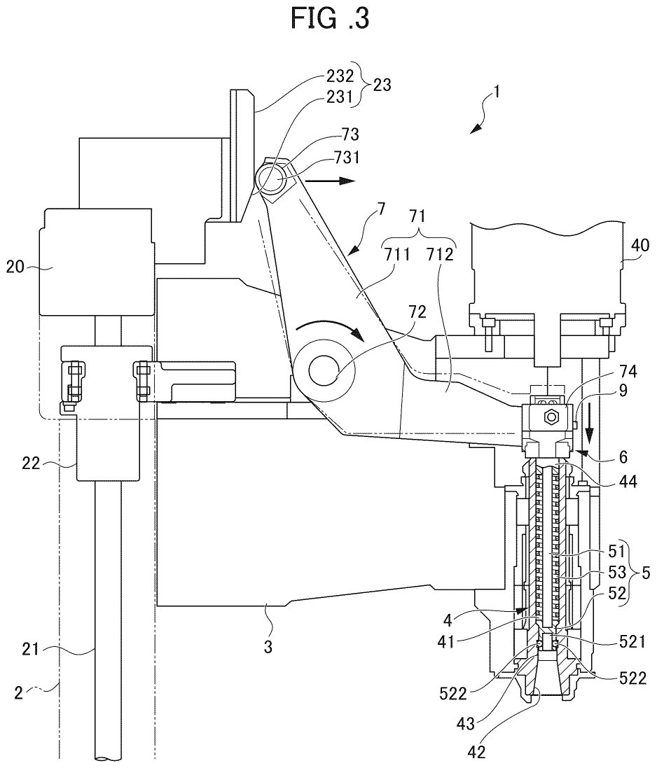

The column 2 is a support rod for the machine tool 1, the support rod extending in a direction substantially perpendicular to a worktable (not shown). As depicted in FIGS. 2 and 3, the column 2 has a translation axes 21 disposed therein. The translation axes 21 extends in the up-down direction in the column 2. For example, the translation axes 21 is formed from a ball screw. The translation axes 21 rotates about an axis by being driven by a translation axes motor 20 formed from a servo motor provided on the upper end of the column 2.

The spindle head 3 is supported by the column 2 in such a manner as to be capable of moving in the up-down direction. The spindle head 3 extends from the column 2 in a direction substantially orthogonal to the direction in which the column 2 extends. The spindle 4, which is described hereinafter, is supported by a leading end portion of the spindle head 3 that is distant from the column 2. A base end portion of the spindle head 3 that is close to the column 2 is connected to the translation axes 21 of the column 2. In particular, as depicted in FIGS. 2 and 3, the base end portion of the spindle head 3 is connected to a nut member 22 screwed to the translation axes 21. When the translation axes 21 rotates by being driven by the translation axes motor 20, the nut member 22 moves up and down along the translation axes 21. As a result, the spindle head 3 connected to the nut member 22 moves up and down along the column 2, thereby causing the spindle 4 to move up and down.

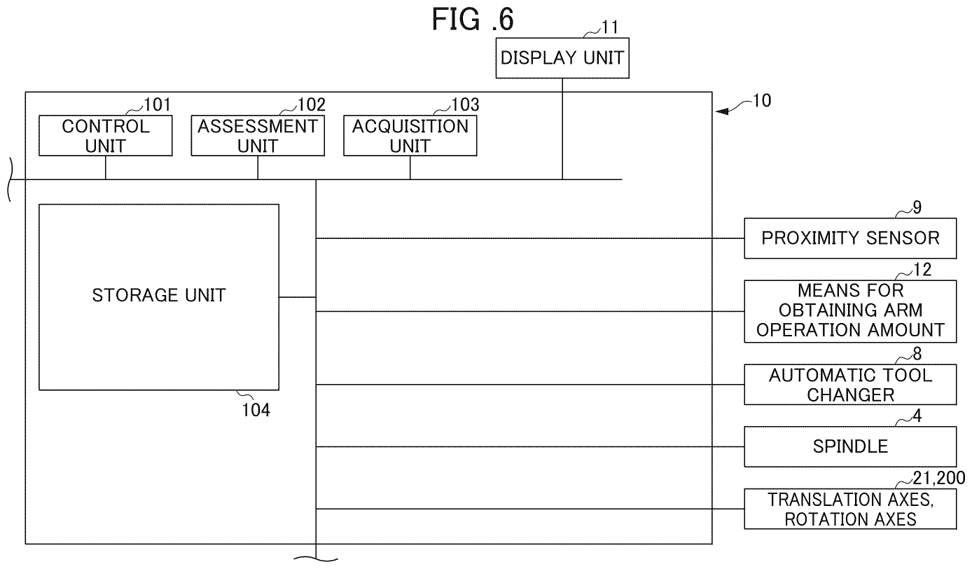

The spindle 4 is provided on the leading end portion of the spindle head 3 in such a manner as to extend in the up-down direction. The spindle 4 is formed in a substantially cylindrical shape having a hollow section 41 extending in the up-down direction. The spindle 4 is provided in such a manner as to be capable of rotating about an axis extending in the up-down direction by being driven by the spindle motor 40 depicted in FIGS. 2 and 3. In this way, the machine tool 1 machines a workpiece (not shown) by rotating a tool 80 clamped to the spindle 4. The workpiece is attached to a rotation or translation table (not shown) that has translation axes 21 or rotation axes 200 (see FIG. 6). The spindle 4 has, at the lower end portion thereof, a conical tool accommodation section 42 in which the diameter of the hollow section 41 increases downward. The tool accommodation section 42 accommodates a conical section 82 provided at the upper end portion of the tool 80. The spindle 4 has a space section 43 between the hollow section 41 and the tool accommodation section 42, the space section 43 being formed in such a manner as to have a diameter larger than the inner diameter of the hollow section 41. An upper end portion of the hollow section 41 of the spindle 4 is provided with a cylindrical support section 44 for supporting the drawbar 5 (described hereinafter).

The drawbar 5 is disposed in the hollow section 41 of the spindle 4 and provided in such manner as to be capable of moving forward/rearward in the spindle 4. In this regard, the wordings “forward” and “rearward” are defined for the drawbar 5 as follows. The wording “forward” for the drawbar 5 indicates the side of the drawbar 5 on which the tool 80 is disposed. The wording “rearward” for the drawbar 5 indicates the side of the drawbar 5 that is opposite to the side on which the tool 80 is disposed. With respect to the illustrated embodiments, the wordings “forward” and “rearward” for the drawbar 5 correspond to the “downward” and “upward” in the drawings. In the following descriptions, accordingly, “forward” is represented as “downward” and “rearward” is represented as “upward” for the movement direction and the biased direction of the drawbar 5. As depicted in FIG. 2, the drawbar 5 has a drawbar body 51, a tool gripping section 52, and a biasing member 53.

The drawbar body 51 extends in the up-down direction along the inside of the hollow section 41 of the spindle 4. The drawbar body 51 is accommodated in the hollow section 41 of the spindle 4 at a position above the tool accommodation section 42. The outer diameter of the drawbar body 51 is smaller than the inner diameter of the hollow section 41 of the spindle 4. Thus, a gap is formed between the inner surface of the hollow section 41 of the spindle 4 and the outer surface of the drawbar body 51. The upper end portion of the drawbar body 51 is inserted into the support section 44 of the spindle 4 in such a manner as to be capable of moving up and down. The drawbar body 51 has an air passage 511 extending in the up-down direction along a central axis (see FIGS. 7A, 7B, and 7C).

The tool gripping section 52 is provided integrally with the lower end portion of the drawbar body 51. The tool gripping section 52 is formed in such a manner as to have a larger diameter than the outer diameter of the drawbar body 51. The tool gripping section 52 has a recessed section 521 opened downward so as to accommodate a pull stud 81 provided at the upper end of the tool 80. A plurality of balls 522 are arranged in the circumferential direction on the peripheral surface of a lower end portion of the tool gripping section 52 that forms the outer peripheral wall of the recessed section 521. The plurality of balls 522 are provided in such a manner as to be capable of moving radially with respect to the tool gripping section 52 by being loosely attached to the tool gripping section 52. The lower end of the air passage 511 of the drawbar body 51 is in communication with the recessed section 521 of the tool gripping section 52.

The biasing member 53 is disposed in the gap between the inner surface of the hollow section 41 of the spindle 4 and the outer surface of the drawbar body 51. For example, the biasing member 53 is formed from a coil spring. The biasing member 53 is provided so as to bias the drawbar body 51 upward against the support section 44 of the spindle 4 all the time.

The air injector 6 is connected to the upper end portion of the drawbar 5. The air injector 6 is formed from a column-shaped body formed from a metal and disposed coaxially with the drawbar 5. As depicted in FIGS. 7A, 7B, and 7C, an air injection passage 61 is provided inside the air injector 6. One end of the air injection passage 61 is in communication with the upper end of the air passage 511 of the drawbar body 51. The air injector 6, which is connected to an air supply source (not shown), supplies air supplied from the air supply source to the air passage 511 of the drawbar body 51 via the air injection passage 61. The air supplied to the drawbar body 51 is blown into the recessed section 521 of the tool gripping section 52. As a result, foreign matter adhered to the inside of the recessed section 521 of the drawbar body 51 and to the conical section 82 of the tool 80 is cleaned off.

When the tool 80 is changed by means of the drawbar 5, the air injector 6 also functions as a component that is subjected to a depression manipulation performed using the arm 7 described hereinafter. The air injector 6 is disposed above the spindle 4 and connected to the upper end portion of the drawbar body 51. Thus, the air injector 6 is an interlock component that interlocks with the upward/downward movement of the drawbar 5. The air injector 6 is formed in such a manner as to have a larger diameter than the spindle 4. An upper end surface 62 of the air injector 6 is formed from an annular flat surface. The upper end surface 62 of the air injector 6 is subjected to the depression manipulation performed using the arm 7 described hereinafter.

The arm 7 has an arm body 71, a turn shaft 72, a cam follower 63, and a depression manipulation part 74.

The arm body 71 is turnably supported on an upper portion of the spindle head 3 by the turn shaft 72. The turn shaft 72 extends in a direction that is orthogonal to the direction in which the column 2 extends and that is also orthogonal to the direction in which the spindle head 3 extends. The arm body 71 is formed substantially in an L shape that has a first arm section 711 extending from the turn shaft 72 along the spindle head 3 toward the spindle 4, and a second arm section 712 extending upward from the turn shaft 72. The arm body 71 can turn about the turn shaft 72 clockwise or counterclockwise with reference to FIGS. 1 to 3.

The cam follower 73 is provided at the leading end of the first arm section 711 of the arm body 71. For example, the cam follower 73 is formed from a column-shaped body. The cam follower 73 is rotatably provided on a turn shaft 731 disposed parallel to the turn shaft 72.

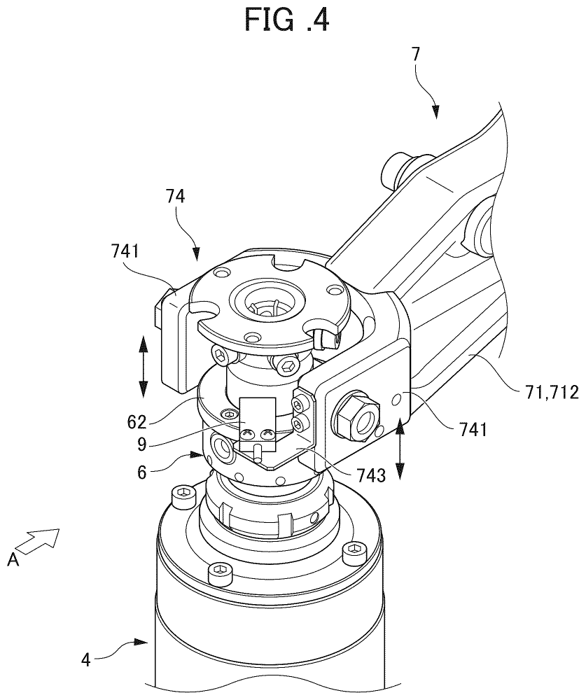

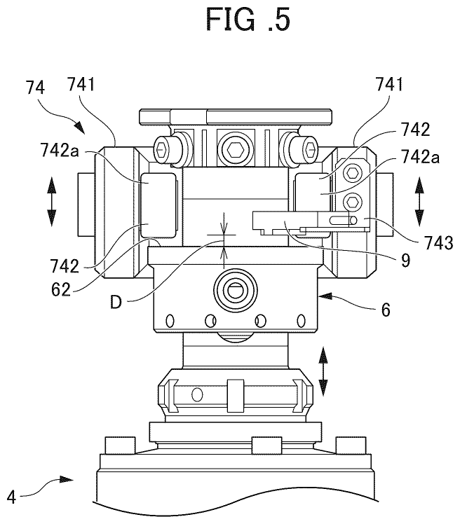

The depression manipulation part 74 is provided at the leading end of the second arm section 712 of the arm body 71. As depicted in FIGS. 4 and 5, the depression manipulation part 74 has one pair of arm sections 741 disposed in such a manner as to clamp the air injector 6 from two radial sides. As depicted in FIG. 5, a column-shaped depression member 742 is attached to each of inner surfaces of the one pair of arm sections 741 that are oriented toward each other. Central axes of the depression members 742 extend in the direction in which the depression members 742 are oriented toward each other, and are located at the same height with reference to the upper end surface 62 of the air injector 6. Outer peripheral surfaces 742a of the depression members 742 are disposed in such a manner as to face the upper end surface 62 of the air injector 6. When the arm 7 is located at a home position as a result of the drawbar 5 having been moved upward by the biasing force of the biasing member 53, the depression members 742 of the depression manipulation part 74 do not abut the upper end surface 62 of the air injector 6, as depicted in FIG. 5. In this situation, the depression members 742 are spaced apart upward from the upper end surface 62 of the air injector 6 by a distance D.

As depicted in FIGS. 1-3, a cam 23 is attached to an upper end portion of the column 2 that is located above the spindle head 3. The cam 23 is provided at a location projecting from the column 2 toward the spindle 4. The cam 23 is formed from a plate-shaped member extending in the direction in which the column 2 extends. The cam 23 has, at the lower end portion hereof, an inclined surface 231 extending upward while being inclined toward the leading end side of the spindle head 3, and also has a flat surface 232 linearly extending in the up-down direction from the upper end of the inclined surface 231. The inclined surface 231 and the flat surface 232 are continuous in the up-down direction, thereby forming the cam surface of the cam 23. The cam follower 73 of the arm 7 is disposed slidably on the cam 23 in accordance with the upward/downward movement of the spindle head 3.

When the cam follower 73 of the arm 7 has abutted the inclined surface 231 of the cam 23, the arm 7 turns counterclockwise as depicted in FIGS. 1 and 2, thereby disposing the depression manipulation part 74 at the maximally high position. When the cam follower 73 of the arm 7 has abutted the flat surface 232 of the cam 23, the arm 7 turns clockwise as depicted in FIG. 3, thereby disposing the depression manipulation part 74 at a low position. As a result of the turn of the arm 7, the depression members 742 of the depression manipulation part 74 come into contact with or are separated from the upper end surface 62 of the air injector 6.

The automatic tool changer (ATC) 8 is a disc-shaped device that holds a plurality of tools 80. The automatic tool changer 8 is rotatably attached to the machine tool 1 such that a tool attached to the spindle 4 can be changed with a desired tool 80 in accordance with what work is to be performed. However, the automatic tool changer 8 does not necessarily need to be provided to the machine tool 1. A tool 80 has, at the upper end portion thereof, a pull stud 81 to be accommodated in the recessed section 521 of the tool gripping section 52 of the drawbar 5, and a conical section 82 provided below the pull stud 81. The conical section 82 has a shape matching the inner surface shape of the tool accommodation section 42 of the spindle 4.

The proximity sensor 9 senses the approach of an object in a noncontact manner. The proximity sensor 9 has a coil for generating a high-frequency magnetic field, and senses an impedance variation caused by an induced current flowing through a detected object when the detected object has been brought close to the magnetic field. When an impedance variation, which is sensed in response to a detected object being brought close, has reached a prescribed threshold, the proximity sensor 9 outputs an ON/OFF signal to the controller 10 (see FIG. 6).

The proximity sensor 9 in the present embodiment is fixed to the depression manipulation part 74 of the arm 7. In particular, as depicted in FIGS. 4 and 5, an L-shaped bracket 743 is attached to one arm section 741 of the depression manipulation part 74 of the arm 7. The proximity sensor 9 is attached to the bracket 743 and moves up and down together with the depression manipulation part 74 of the arm 7. The proximity sensor 9 is disposed above the upper end surface 62 of the air injector 6 in such a manner as to be attached to the bracket 743 and oriented toward the upper end surface 62. The lower surface of the proximity sensor 9 is disposed at the same position as the lower ends of the depression members 742 of the depression manipulation part 74, and spaced apart upward from the upper end surface 62 of the air injector 6. With the upper end surface 62 of the air injector 6 as a detected object, the proximity sensor 9 detects whether the upper end surface 62 of the air injector 6 has reached a position at a prescribed distance.

The proximity sensor 9 may output an ON signal when the upper end surface 62 of the air injector 6 has reached a position at a prescribed distance, or may output an OFF signal when the upper end surface 62 of the air injector 6 has reached a position at the prescribed distance. The present embodiment is described by referring to situations in which the proximity sensor 9 outputs an ON signal when having been separated from the upper end surface 62 of the air injector 6 by a prescribed distance, and outputs an OFF signal when having reached a position at the prescribed distance from the upper end surface 62 of the air injector 6. In the present embodiment, the prescribed distance is set to the distance D, which is provided between the proximity sensor 9 and the upper end surface 62 of the air injector 6 when the arm 7 is disposed at the home position. Accordingly, the proximity sensor 9 is configured to be put in an ON state at a timing at which the same is separated from the upper end surface 62 of the air injector 6 by greater than the distance D, and put in an OFF state at a timing at which the same has reached a position at the distance D or less from the upper end surface 62 of the air injector 6.

FIG. 6 illustrates a functional block diagram of the controller 10. The controller 10 has a control unit 101, an assessment unit 102, an acquisition unit 103, and a storage unit 104. The controller 10 may be provided to the machine tool 1, or may be provided to a numerical control device (not shown) that controls the operations of the machine tool 1.

The control unit 101 controls various types of processing performed by the controller 10. Specifically, the control unit 101 controls the driving of the automatic tool changer 8, the translation axes motor 20, and the spindle motor 40 in order to allow the machine tool 1 to perform a clamping or unclamping operation for a tool 80.

The assessment unit 102 compares a detection value that is obtained at a timing at which the ON/OFF state sent from the proximity sensor 9 is switched with a normal value that is preset in the storage unit 104 for a timing at which the ON/OFF state is switched. The assessment unit 102 assesses the presence/absence of a clamping abnormality of the tool 80 and the presence/absence of an abnormality of the proximity sensor 9 on the basis of the result of the comparison. The assessment unit 102 also assesses whether tool change is being currently performed by monitoring a signal with which the control unit 101 controls the automatic tool changer 8. Furthermore, the assessment unit 102 determines, according to an operation amount obtained for the arm 7 by a means 12 (described hereinafter) for obtaining an arm operation amount, whether the operation amount of the arm 7 is normal.

The acquisition unit 103 acquires an ON/OFF signal from the proximity sensor 9 and outputs the same to the assessment unit 102.

The storage unit 104 stores a normal value for a timing at which the ON/OFF state of the proximity sensor 9 for assessing the presence/absence of a clamping abnormality is switched.

In FIG. 6, the display unit 11 is formed from, for example, a liquid-crystal display. The display unit 11 is connected to the controller 10 and displays various types of data sent from the controller 10 on a screen.

In FIG. 6, the means 12 for obtaining an arm operation amount is formed from, for example, an encoder provided at the turn shaft 72 of the arm 7. The means 12 for obtaining an arm operation amount obtains the operation amount of the arm 7, thereby detecting that the arm 7 has started to turn from the home position normally or returned to the home position normally in order to clamp or unclamp a tool 80. It can be determined whether the operation amount of the arm 7 is normal by comparing a turn amount detected for the arm 7 by the encoder with a normal value preset in the storage unit 104 for the turn amount. For example, when the difference of the turn amount of the arm 7 from the normal value is equal to or less than a prescribed threshold, the assessment unit 102 assesses that the operation amount of the arm 7 is normal. The means 12 for obtaining an arm operation amount outputs the detection result to the acquisition unit 103.

Main units of the controller 10 are formed from a processor. The controller 10, which is formed from the processor, stores, in a nonvolatile manner in a memory functioning as the storage unit 104, a control program executed by the processor and data processed by the controller 10. The memory is formed from a magnetic storage device, a semiconductor storage element such as a flash read only memory (flash ROM), or another type of nonvolatile storage device. The memory may include a random access memory (RAM) forming a work area for the processor. For example, the functions of the control unit 101, the assessment unit 102, and the acquisition unit 103 of the controller 10 are implemented by the processor executing prescribed software (program, application) stored in the memory.

By referring to FIGS. 7A to 7C, the following describes the positions of the drawbar 5 and the air injector 6 and the ON/OFF state of the proximity sensor 9 during the clamping or unclamping of a tool 80.

FIG. 7A depicts the spindle 4 without a tool 80 being attached thereto. In this case, the arm 7 is disposed at the home position. In particular, the arm 7 disposes the depression members 742 of the depression manipulation part 74 at the maximally high position. The drawbar 5 has been moved to the maximally high position by the upward biasing force of the biasing member 53. The upper end surface 62 of the air injector 6, which interlocks with the drawbar 5, is disposed at a position P0. The position P0 is equal to the distance D, which is a prescribed distance at which the ON/OFF state of the proximity sensor 9 is switched. Thus, the proximity sensor 9 is in the OFF state.

FIG. 7B depicts the spindle 4 with a tool 80 having been clamped thereto normally. The drawbar 5 has been moved upward by the biasing force of the biasing member 53, and grips, by means of the plurality of balls 522, the pull stud 81 of the tool 80 accommodated in the recessed section 521 of the tool gripping section 52, thereby clamping the tool 80. The conical section 82 of the tool 80 abuts the inner circumferential surface of the tool accommodation section 42 of the spindle 4 such that the upward movement of the drawbar 5 is restricted. The upper end surface 62 of the air injector 6 is disposed at a position P1 located below the position P0. Thus, when the arm 7 has returned to the home position, the proximity sensor 9 is in the ON state. In other words, the proximity sensor 9 being in the ON state when the arm 7 is located at the home position indicates that the tool 80 has been clamped to the spindle 4.

FIG. 7C indicates a tool 80 in the process of being detached. The depression members 742 of the depression manipulation part 74 of the arm 7 press the upper end surface 62 of the air injector 6 downward, thereby causing the drawbar 5 to move against the biasing force of the biasing member 53 to the maximumly low position. As a result, the plurality of balls 522 provided to the tool gripping section 52 are disposed in the space section 43 of the spindle 4. The plurality of balls 522 move radially outward from the tool gripping section 52, thereby putting the tool 80 in the unclamped state. The upper end surface 62 of the air injector 6 is disposed at a position P2 located below the position P1, so the proximity sensor 9 is in the ON state when the arm 7 has returned to the home position.

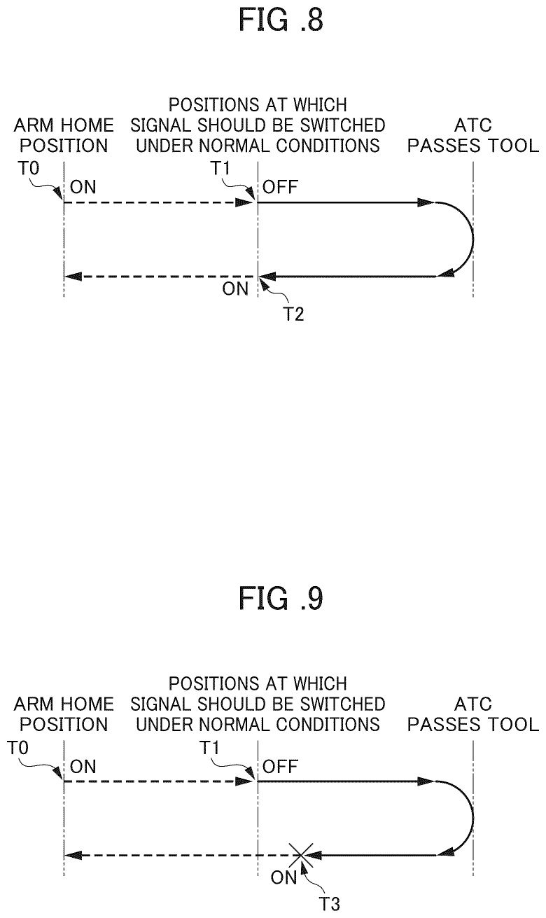

By referring to FIGS. 8 and 9, the following further describes the ON/OFF state of the proximity sensor 9 during the clamping or unclamping of a tool 80 that is performed in the manner described above. In FIGS. 8 and 9, broken lines indicate regions in which the proximity sensor 9 is in the ON state, and solid lines indicate regions in which the proximity sensor 9 is in the OFF state.

First, by referring to FIG. 8, descriptions are given of a situation in which a tool 80 is clamped normally. While the tool 80 is not attached (state depicted in FIG. 7A), the arm 7 is disposed at the home position (timing T0). In this case, the upper end surface 62 of the air injector 6 is disposed at the position P0. Thus, the proximity sensor 9 is in the ON state and outputs an ON signal to the controller 10.

Afterward, in order to clamp the tool 80, the depression manipulation part 74 of the arm 7 is moved downward, thereby causing the depression members 742 to press the upper end surface 62 of the air injector 6 downward until the upper end surface 62 is disposed at the position P2, as depicted in FIG. 7C. During the operation of pressing downward, the proximity sensor 9 is switched to the OFF state at a timing T1 at which the same has reached a position at the distance D or less from the upper end surface 62 of the air injector 6.

Upon the tool 80 being passed from the automatic tool changer 8 to the drawbar 5 and clamped normally, the upper end surface 62 of the air injector 6 is disposed at the position P1, as depicted in FIG. 7B. The position P1 is located below the position P0. Thus, during the process of the arm 7 turning toward the home position, the proximity sensor 9 is switched to the ON state again at a timing T2 at which the same is separated from the upper end surface 62 of the air injector 6 by greater than the distance D.

As indicated above, when the tool 80 is clamped to the spindle 4 by the drawbar 5 normally, a time T1-T2 is required that extends from the timing T1, at which the proximity sensor 9 is switched from the ON state to the OFF state, to the timing T2, at which the same is switched to the ON state again.

By contrast, if, for example, foreign matter is caught between the conical section 82 of the tool 80 and the tool accommodation section 42 during the clamping of the tool 80, the tool 80 is put in a half-clamped state in which the same is not clamped normally. In this case, when the drawbar 5 is moved upward by the biasing force of the biasing member 53 upon the arm 7 returning to the home position, the upper end surface 62 of the air injector 6 does not return to the position P1 depicted in FIG. 7B, at which the upper end surface 62 should be located when normal clamping has been achieved. The upward movement of the drawbar 5 is interfered with by foreign matter being caught, so the upper end surface 62 of the air injector 6 is disposed below the position P1. As a result, during the process of the arm 7 returning to the home position, the proximity sensor 9 is separated from the upper end surface 62 of the air injector 6 by greater than the distance D in a short time. Hence, as indicated in FIG. 9, a time T1-T3, which is a required time extending from the timing T1 at which the proximity sensor 9 is switched from the ON state to the OFF state to a timing T3 at which the same is switched to the ON state again, is shorter than the time T1-T2 indicated in FIG. 8 required under normal conditions.

The time T1-T2, which is based on the timings in the case of the normal clamping of the tool 80, is stored as a normal value in the storage unit 104 of the controller 10. During a tool change operation, the assessment unit 102 detects timings at which the ON/OFF signal output from the proximity sensor 9 is switched, and compares the detected timings with the time T1-T2 stored in the storage unit 104 as a normal value. If it is determined according to the result of the comparison that the detection value is lower than the normal value by greater than a prescribed threshold determined in advance, the assessment unit 102 assesses that a clamping abnormality of the tool 80 caused by mis-clamping has occurred.

During the tool change operation, the depression manipulation part 74 of the arm 7 presses the upper end surface 62 of the air injector 6 downward, so the proximity sensor 9 is brought close to the upper end surface 62 and thus should be put in the OFF state. Hence, if the proximity sensor 9 does not transition to the OFF state during the tool change operation, it can be determined that an abnormality of the proximity sensor 9, e.g., failure, has occurred. The assessment unit 102 assesses the presence/absence of occurrence of an abnormality of the proximity sensor 9 by determining whether the proximity sensor 9 has transitioned to the OFF state during the tool change operation.

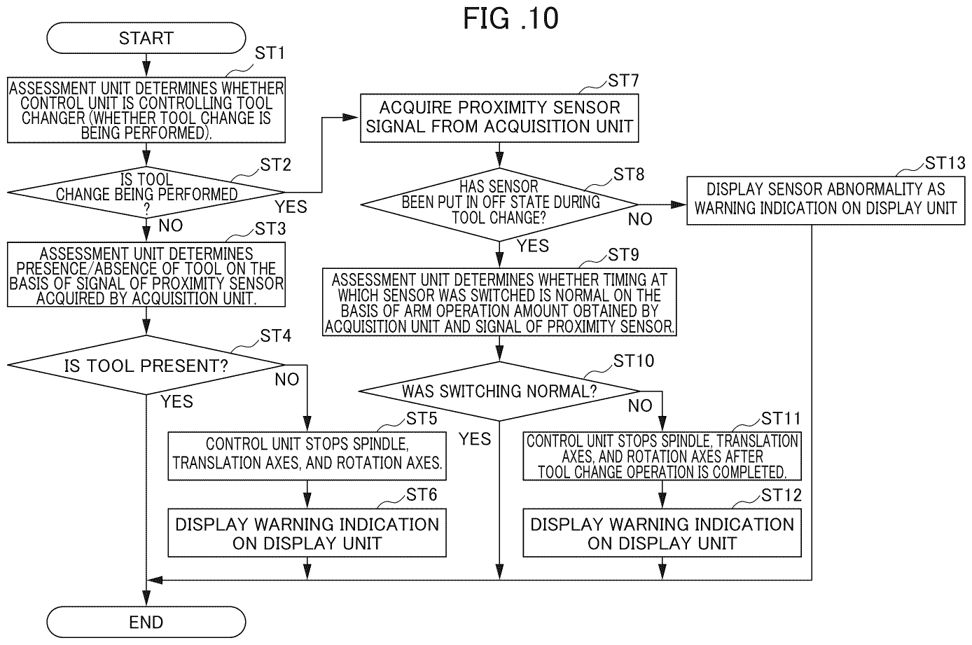

Next, by referring to the flowchart in FIG. 10, descriptions are given of one embodiment of specific assessment processing performed by the controller 10 for the presence/absence of a clamping abnormality and the presence/absence of the movement of the proximity sensor 9.

First, after the machine tool 1 starts to be operated, the assessment unit 102 of the controller 10 determines whether the control unit 101 is in a state of controlling the automatic tool changer 8 (Step ST1). In this way, the assessment unit 102 assesses whether tool change is being performed for the machine tool 1 (Step ST2).

When the assessment unit 102 has assessed in Step ST2 that tool change is not being performed for the machine tool 1 (Step ST2: NO), the assessment unit 102 determines the presence/absence of a tool 80 at the spindle 4 according to a signal of the proximity sensor 9 acquired by the acquisition unit 103 (Step ST3). In particular, when the spindle 4 has clamped a tool 80, the upper end surface 62 of the air injector 6 is disposed at the position P1 as depicted in FIG. 7B, so the proximity sensor 9 is in the ON state. On the basis of the detection state of the proximity sensor 9 obtained from the acquisition unit 103, the assessment unit 102 determines whether a tool 80 has been clamped to the spindle 4 (Step ST4). When the assessment unit 102 has assessed in Step ST4 that a tool 80 has been clamped to the spindle 4 (Step ST4: YES), the assessment unit 102 determines that machining work can be performed with the machine tool 1, and outputs a signal to this effect to the control unit 101, thereby ending the assessment processing.

When the assessment unit 102 has assessed in Step ST4 that a tool 80 has not been clamped to the spindle 4 (Step ST4: NO), the assessment unit 102 outputs an absence-of-tool signal to the control unit 101. As a result, the control unit 101 performs stop control for the spindle 4, the translation axes 21, and the rotation axes 200 (Step ST5). Afterward, the control unit 101 displays absence-of-tool information on the display unit 11 as a warning indication (Step ST6).

When having assessed in Step ST2 that tool change is being performed for the machine tool 1 (Step ST2: YES), the assessment unit 102 acquires the ON/OFF signal of the proximity sensor 9 from the acquisition unit 103 (Step ST7). During tool change, the proximity sensor 9 should be brought close to the upper end surface 62 of the air injector 6 and output an OFF signal. Thus, during tool change, the assessment unit 102 monitors the signal of the proximity sensor 9 acquired from the acquisition unit 103 and determines whether the OFF signal of the proximity sensor 9 has been output (Step ST8).

When the assessment unit 102 has assessed in Step ST8 that the OFF signal of the proximity sensor 9 has been output (Step ST8: YES), the assessment unit 102 monitors the operation amount of the arm 7 that is obtained by the acquisition unit 103 from the means 12 for obtaining an arm operation amount and a timing at which the ON/OFF state of the proximity sensor 9 is switched, and determines whether the operation amount and the timing are normal (Step ST9). In particular, the assessment unit 102 determines whether the operation amount of the arm 7 that is obtained from the means 12 for obtaining an arm operation amount lies within the range of normal values set in the storage unit 104, and whether a detection value for the time between timings at which the ON/OFF state of the proximity sensor 9 was switched lies within the range of normal values set in the storage unit 104 (Step ST10).

When the assessment unit 102 has assessed in Step ST10 that the operation amount of the arm 7 and the timing at which the proximity sensor 9 was switched are both normal (Step ST10: YES), the assessment unit 102 determines that the tool 80 has been changed normally and thus machining work can be performed with the machine tool 1, and outputs a signal to this effect to the control unit 101, thereby ending the assessment processing.

During tool change, for example, if the tool 80 is not clamped normally due to foreign matter being caught between the tool accommodation section 42 of the spindle 4 and the conical section 82 of the tool 80 or if the operation amount of the arm 7 is not normal due to the cam follower 73 of the arm 7 not sliding on the cam 23 normally, then the assessment unit 102 assesses in Step ST10 that at least either the operation amount of the arm 7 or the timing at which the proximity sensor 9 was switched is not normal (Step ST10: NO). Accordingly, the assessment unit 102 assesses that the tool 80 has not been clamped normally, and outputs a signal to this effect to the control unit 101.

Upon receipt of the signal indicating that the tool 80 has not been clamped normally from the assessment unit 102, the control unit 101 stops the spindle 4, the translation axes 21, and the rotation axes 200 after the tool change operation is completed (Step ST11). Afterward, the control unit 101 displays information indicating that the tool 80 has not been clamped normally on the display unit 11 as a warning indication (Step ST12).

When having assessed in Step ST8 that the OFF signal of the proximity sensor 9 has not been output (Step ST8: NO), the assessment unit 102 determines that, during the tool change, the proximity sensor 9 did not reach a position at less than a prescribed distance from the upper end surface 62 of the air injector 6. Thus, the assessment unit 102 outputs, to the control unit 101, a signal indicating that an abnormality of the proximity sensor 9 caused by, for example, a failure has occurred. Accordingly, the control unit 101 displays the abnormality of the proximity sensor 9 as a warning indication on the display unit 11.

In the embodiments described above, the proximity sensor 9 is fixed to the depression manipulation part 74 of the arm 7 and configured to switch the ON/OFF state in accordance with the distance to the upper end surface 62 of the air injector 6. However, the proximity sensor 9 may be fixed to the air injector 6 and configured to switch the ON/OFF state in accordance with the distance to the depression manipulation part 74 of the arm 7.

The machine tool 1 can detect the presence/absence of a tool 80 at the spindle 4 and a mis-clamped state of the tool 80 by means of one proximity sensor 9 fixed to the arm 7. Accordingly, not only the presence/absence of a tool 80 at the spindle 4 but also a mis-clamped state of the tool 80 can be detected without increasing the number of sensors to be attached to the machine tool 1.

The assessment unit 102 of the machine tool 1 determines the presence/absence of a clamping abnormality of the tool 80 simply by comparing a detection value for a timing at which the ON/OFF state of the proximity sensor 9 was switched with a normal value. Complicated arithmetic processing does not need to be performed on the basis of a detection value obtained by the sensor. Thus, the circuit configuration for the assessment processing on a clamping abnormality is simplified.

The assessment unit 102 of the machine tool 1 assesses, on the basis of the ON/OFF state of the proximity sensor 9 during tool change, the presence/absence of an abnormality of the proximity sensor 9, so configurations for an abnormality assessment of the proximity sensor 9 do not need to be additionally provided. Thus, the circuit configuration for the abnormality assessment processing for the proximity sensor 9 is simplified.

The following additional remarks are further disclosed with respect to the above-described embodiments and variations.

### Additional Remark 1

A machine tool (1), for which a tool (80) to be clamped to a spindle (4) is capable of being automatically changed, includes: a drawbar (5) that is biased upward by a biasing member (53), clamps the tool (80) to the spindle (4) by being moved upward, and unclamps the tool (80) from the spindle (4) by being moved downward; an interlock component (6) that is connected to the drawbar (5) and interlocks with the upward/downward movement of the drawbar (5); an arm (7) that presses the interlock component (6) downward in order to move the drawbar (5) downward against the biasing member (53); a proximity sensor (9) that is fixed to the arm (7) or the interlock component (6) and provides an output switched between ON and OFF in accordance with the distance between the arm (7) and the interlock component (6); and an assessment unit (102) that assesses the clamped state of the tool (80) on the basis of the ON/OFF state of the proximity sensor (9).

### Additional Remark 2

The machine tool (1) according to additional remark 1, the machine tool including a storage unit (104) that stores a normal value for a timing at which the ON/OFF state of the proximity sensor (9) during a tool change operation is switched, wherein the assessment unit (102) assesses the presence/absence of a clamping abnormality of the tool (80) on the basis of the result of the comparison between a detection value for a timing at which the ON/OFF state of the proximity sensor (9) was switched and the normal value stored by the storage unit (104).

### Additional Remark 3

The machine tool (1) according to additional remark 1 or 2, wherein the assessment unit (102) assesses the presence/absence of an abnormality of the proximity sensor (9) on the basis of the ON/OFF state of the proximity sensor (9) during tool change.

Although the present disclosure has been described in detail, the present disclosure is not limited to the individual embodiments described above. These embodiments can have various features added thereto, can have various features replaced with those therein, can have various changes made therein, and can be subjected to partial deletion without departing from the gist of the present disclosure or without departing from the spirit of the present disclosure that is derived from the details set forth in the claims and equivalents of the details. These embodiments may also be implemented in combination with each other. In the embodiments described above, for example, the orders in which operations or processes are performed are indicated as examples, and the present invention is not limited to such orders. This is also true of any numerical values and numerical equations or expressions referred to with respect to the embodiments described above.

### EXPLANATION OF REFERENCE NUMERALS

1: Machine tool
4: spindle
5: Drawbar
6: Air injector (interlock component)
7: Arm
9: Proximity sensor
80: Tool
53: Biasing member
102: Assessment unit
104: Storage unit

1. A machine tool for which a tool to be clamped to a main shaft is capable of being changed, the machine tool comprising:
a drawbar that is biased rearward by a biasing member, clamps the tool to the main shaft by being moved rearward, and unclamps the tool from the main shaft by being moved forward;
an interlock component that is connected to the drawbar and interlocks with forward/rearward movement of the drawbar;
an arm that presses the interlock component forward in order to move the drawbar forward against the biasing member;
a proximity sensor that is fixed to the arm or the interlock component and provides an output switched between ON and OFF in accordance with a distance between the arm and the interlock component; and
an assessment unit that assesses a clamped state of the tool on a basis of an ON/OFF state of the proximity sensor.

2. The machine tool according to claim 1, comprising a storage unit that stores a normal value for a timing at which the ON/OFF state of the proximity sensor during a tool change operation is switched, wherein
the assessment unit assesses presence/absence of a clamping abnormality of the tool on a basis of a result of a comparison between a detection value for a timing at which the ON/OFF state of the proximity sensor was switched and the normal value stored by the storage unit.

3. The machine tool according to claim 1, wherein
the assessment unit assesses presence/absence of an abnormality of the proximity sensor on a basis of the ON/OFF state of the proximity sensor during tool change.
